(19) United States
(12) Patent Application Publication
(10) Pub. No.: US 2021/0387215 A1
(43) Pub. Date: Dec. 16, 2021

(54) Airstream Propelled Spray Atomizer Apparatus and Method of Fluid Atomization by Codirectional Airstream Propulsion

(71) Applicant: JTB Holdings, LLC, Littleton, CO (US)

(72) Inventor: Jerry L. FENLEY, JR., Gonzales, LA (US)

(21) Appl. No.: 17/343,676

(22) Filed: Jun. 9, 2021

Related U.S. Application Data
(60) Provisional application No. 63/037,313, filed on Jun. 10, 2020.

(51) Int. Cl. B05B 7/06; B05B 7/12

(52) U.S. Cl. CPC B05B 7/066; B05B 7/1236; B05B 7/129

(57) ABSTRACT

An airstream propelled spray atomizer apparatus and method of fluid atomization by codirectional airstream propulsion enables controllable atomization of a second fluid into a first fluid for use in surface treatment and cleaning. A user is able to alter the amount of atomization of the second fluid, from a spray to a mist, during spray operations without having to stop and change nozzles. Further, effectuating atomization via in-stream introduction rather than via structural impediments disposed interior to the nozzle prolongs nozzle life over extended operations.

### TO ALL WHOM IT MAY CONCERN

Be it known that I, Jerry L. Fenley, Jr., a citizen of the United States, have invented new and useful improvements in an airstream propelled spray atomizer apparatus and accompanying method of atomizing a fluid by codirectional airstream propulsion, as described in this specification.

### BACKGROUND OF THE INVENTION

Early atomizers seen in the art rely on the Venturi effect to produce a pressure differential in a vertical tube with an opening oriented normal to an airflow that is caused to move tangentially across the opening. The pressure differential created in the vertical tube by the accelerated gas (typically atmosphere) forces liquid, stored in a reservoir in open communication with the tube, up the tube for dispersal behind the airstream pursuant to Bernoulli's principle. The liquid is essentially pulled into the airstream and is typically then dispersible as droplets. Many perfume applicators function in this manner. However, limitations in this model persist, particularly when desiring to atomize spray at relatively higher pressures.

Pressurized atomizers seen in the art typically exploit forcible ejection of fluid through particular spray nozzles, devised to create turbulent flows in the fluid and atomize (or aspirate) the fluid at higher pressures for dispersal as fine droplets. In so doing, most spray atomizers or aspirators rely on structural features of a nozzle through which pressurized fluid is forcibly ejected. These physical, structural features render the nozzle particular to a limited range of applications. Thus, when using an atomized spray for various purposes, and across different ranges of pressures appropriate for different applications as desired, spray nozzles seen in the art are created to be interchangeable—a user simply ceases operations and fits a new nozzle to the fluid conveyance. This presents a number of inefficiencies when conducting spray operations. First, spray operations must be ceased in order to change the nozzle when a different pressure is desired for use, or a different application of fluid is desirously undertook, and second, the forcible contact of the ejected fluid with the nozzle, which is devised to structurally impede the fluid stream through various volumetric changes and/or directions to alter pressure and create turbulence, wears the nozzle with extended use.

What is needed is an airstream propelled spray atomizer apparatus that enables adjustable pressure and spray capacity without the need of interchangeable nozzles to create a range of spray fields and yet allows for high pressure applications of atomized spray.

### FIELD OF THE INVENTION

The present airstream propelled spray atomizer apparatus and associated method of atomizing a fluid by codirectional airstream propulsion provides for pressurized atomization of fluids by introduction of fluid into an accelerated, codirectional airstream. The present airstream propelled spray atomizer apparatus therefore causes, and the method of atomizing a fluid by codirectional airstream propulsion relies on, Rayleigh-Taylor instability (“RT instability”) in the coordinate flows of fluids, which, having different densities, thereby effectuate atomization of the heavier fluid into small droplets for forcible and directable dispersion.

In the present invention, a surrounding flow of a first fluid is accelerated around a terminus oriented codirectional with the direction of the surrounding flow, to create a stream (herein, “airstream,” however, as will be contemplated with the bounds of ordinary skill in the art, the first fluid need not necessarily be “air”) into which a second fluid is introducible by ejection out the terminus. The direction of flow of the second fluid is codirectional with the airstream whereby pressurized ejection of the second fluid into the airstream creates an atomized spray.

The spray produced is therefore controllable by altering the pressure of the first fluid to control application of the second fluid, thereby allowing for user control during active spraying operations without ceasing operations or requiring the interchange of the nozzle. Further, since there are no physical barriers aligned contrary to the direction of fluid flow, wear on the nozzle over extended use is significantly lessened.

### SUMMARY OF THE INVENTION

The present airstream propelled spray atomizer apparatus and associated method of atomizing a fluid by codirectional airstream propulsion has been devised to enable pressurized atomization of fluid for application as a fine spray without the need of interchanging nozzles. Further, the present airstream propelled spray atomizer apparatus allows for control of the spray during active use by regulating the pressure of an airstream to control the spray applied.

As used herein throughout, the term “airstream” and “airflow” refer to a first fluid flow directed down a barrel of an elongate nozzle for ejection out an aperture disposed endwise upon the barrel. Typically, the first fluid is contemplated to be a gas, pressurized for forcible evacuation through the nozzle. Typically, the first fluid is also contemplated to be less dense than a second fluid, which second fluid is introduced into the airstream by emission through a terminus into the airstream. However, alternative embodiments that contemplate the first fluid as a less dense liquid, or even more dense liquid, than the second fluid are also contemplated as within scope of this disclosure; the particular phase of the fluids at issue not necessarily considered as limiting. (For example, it is contemplated as possible to eject a powdered substance in like manner as is herein described.) Thus, the term “fluid” should be taken broadly to mean any phase of really any substance for which the present disclosure may prove useful.

The present airstream propelled spray atomizer, therefore, includes an elongate nozzle having a barrel disposed connected to a pressurized supply of the first fluid. In a preferred embodiment, the first fluid is air and the pressurized supply of the first fluid is compressed air delivered from an air compressor or other compressed air supply. An interior catheter is disposed coaxially within the barrel along a central axis of the barrel and connected with a supply of the second fluid. The interior catheter has a diameter less than the diameter of the barrel sufficient to include a surrounding void between the catheter and the barrel. In a preferred embodiment contemplated herein, the second fluid is a liquid and may be a solution or suspension, such as comprising detergents, disinfectants, surfactants, lubricants, solvents, and other suspensions, solutions, colloids, or other such mixed, dispersed, compounds and/or miscible or immiscible substances as may be useful for application to a targeted object or surface by means of sprayed atomization.

In at least one example embodiment contemplated herein, the barrel of the nozzle may include at least a first section in combination with a second section. In such embodiments, the first section has a diameter that is greater than the diameter of the second section. In such embodiments, the diameter of the barrel approaches the diameter of the catheter, effectively creating at least one narrows within the second section, but still remains large enough to maintain a cylindrical void surrounding the catheter throughout.

The catheter terminates inside the barrel, whereat a terminus of the catheter is seated interior to the barrel at a predetermined distance back from the aperture of the barrel. The barrel thus encapsulates a cylindrical void beyond the position where the catheter terminates and the aperture of the barrel, between the terminus and the aperture. This void constitutes a mixing zone, as will be described subsequently, where a pressure differential between the first fluid, propelled therethrough, and the second fluid, introduced thereinto, enables RT instability to effectively atomize the first fluid into a mist comprising fine droplets for targeted application to a surface.

Consider that when activated, the first fluid is forcibly ejected along the barrel. This creates an airflow surrounding the catheter. Once this airstream is established, the second fluid is introduced into the airstream by forced ejection from the catheter terminus, into the low pressure established and maintained in the barrel mixing zone. The airstream is ejected from the barrel aperture and expands into the surrounding medium (exterior space) to form a cloud comprising fine droplets of the second fluid. The second fluid is atomized in the mixing zone and carried into the airstream codirectionally applied along the barrel length. The narrows caused by the second section of the barrel serves to lower the pressure of the first fluid and, via a Venturi effect, accelerate the airstream previous to the catheter terminus. There is thus a pressure drop interior to the barrel that increases RT instability at the mixing zone proximally downstream from the terminus. The second fluid is atomized in the mixing zone and subjected to RT instability to create a spray of fine droplets dispersed in the airstream as a directable vapor applicable during spray operations.

It should be evident to a person of ordinary skill in the art that no additional or alternative nozzle is required to alter the atomization of the spray produced. RT instability is controllable by controlling the speed that the first fluid is ejected from the aperture. Thus, for example, if ejection of the first fluid is entirely deactivated, the second fluid is ejectable under the pressure supplied to the second fluid supply only (as may be created by action of a pump member, for example), and a stream of liquid is producible, as water is from a garden hose, say. Alternately, the first fluid may be ejected at a maximum rate and the atomization of the second fluid thereby maximized as a fine, misted spray applicable to surfaces as a fine, atomized or aspirated mist. A full spectrum of producible spray—from a liquid stream to a maximized atomized mist—is thereby potentiated without a user having to cease operations and interchange nozzles, as is currently seen in the pressure-washing arts.

It should be noted that, despite the preferred embodiment set forth hereinbelow, the present disclosure is not meant to be limited in application or composition of the first and second fluids. It is contemplated that the present method of atomizing a fluid by codirectional airstream propulsion may be applicable to dispersing even solid particles as may be dispersed by means of a liquid first fluid applied in like manner as set forth herein.

Thus has been broadly outlined the more important features of the present airstream propelled spray atomizer apparatus so that the detailed description thereof that follows may be better understood and in order that the present contribution to the art may be better appreciated.

For better understanding of the airstream propelled spray atomizer apparatus, its operating advantages and specific objects attained by its uses, refer to the accompanying drawings and description. It should be noted that the following detailed description of the drawings is provided as exemplary only. Deviations from the example embodiments shown and described herein, enabling performance of the same method of atomizing a fluid by codirectional airstream propulsion, are contemplated as within the scope of this disclosure, including providing a control circuit operable by electric and/or hydraulic means, in addition to the pneumatic action set forth below, to enable forcible ejection of at least a first fluid and a second fluid as an atomized mist, atomized by action of codirectional airstream (or other fluid stream or flow) propulsion, as set forth herein.

### BRIEF DESCRIPTION OF THE DRAWINGS

### Figures

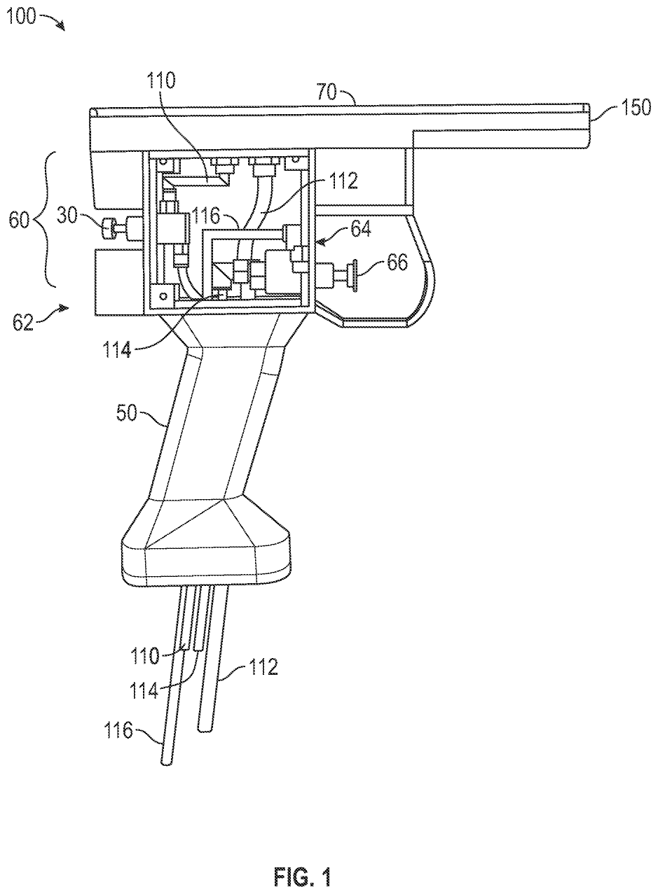

FIG. 1 is a side elevation view of an example embodiment.

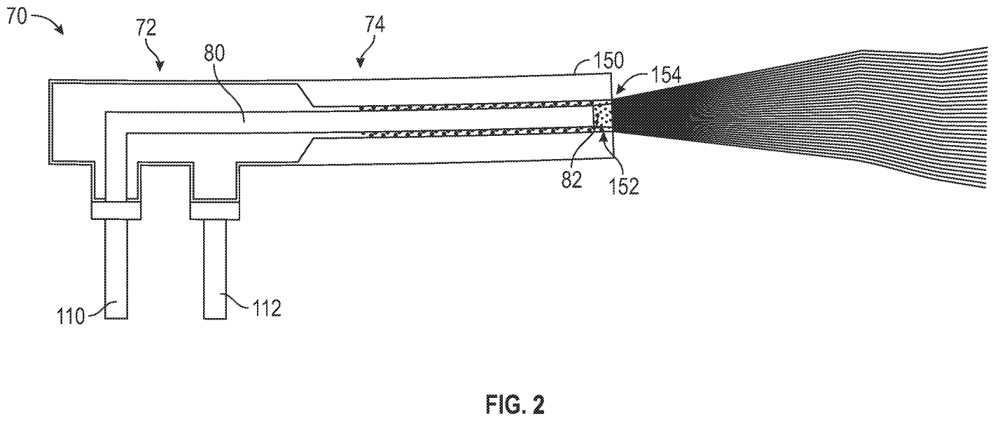

FIG. 2 is a diagrammatic longitudinal cross-section of the barrel of the example embodiment illustrated in FIG. 1.

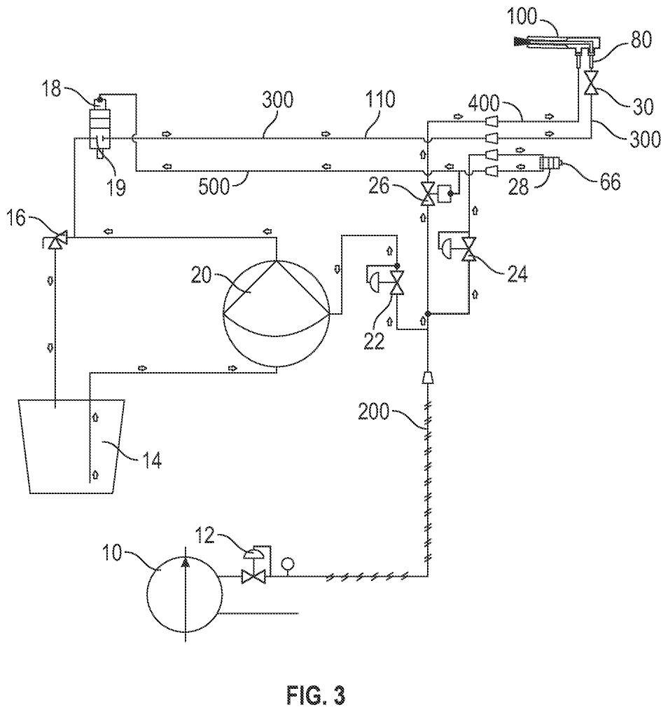

FIG. 3 is a flow diagram view of an example embodiment of the present apparatus and method set forth herein.

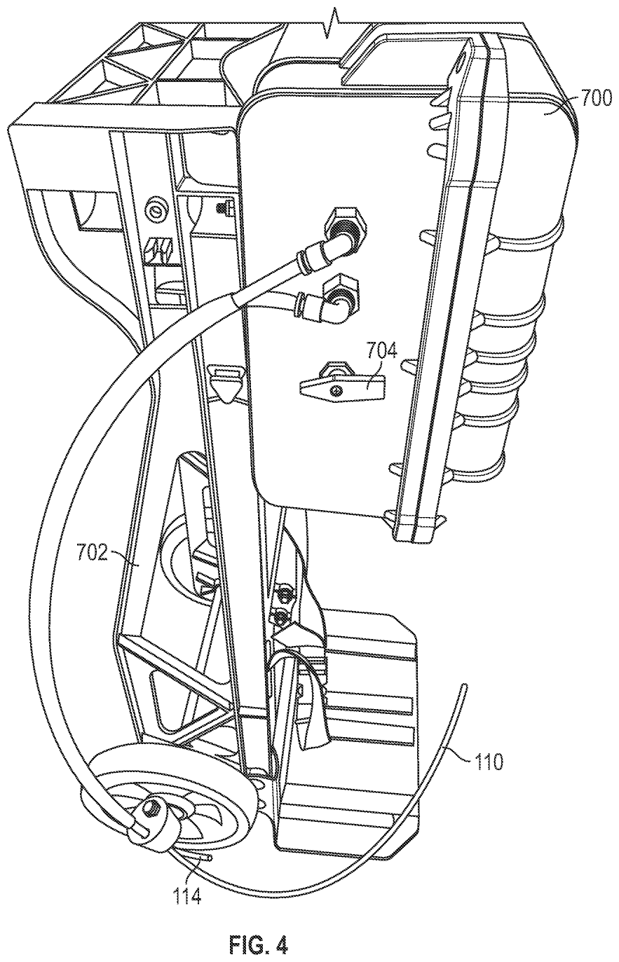

FIG. 4 is a side elevation view of an example embodiment of a fluid supply line and an airflow supply line disposed connected to a control panel, which control panel is mounted on a voluble frame (here, a dolly) for mobility.

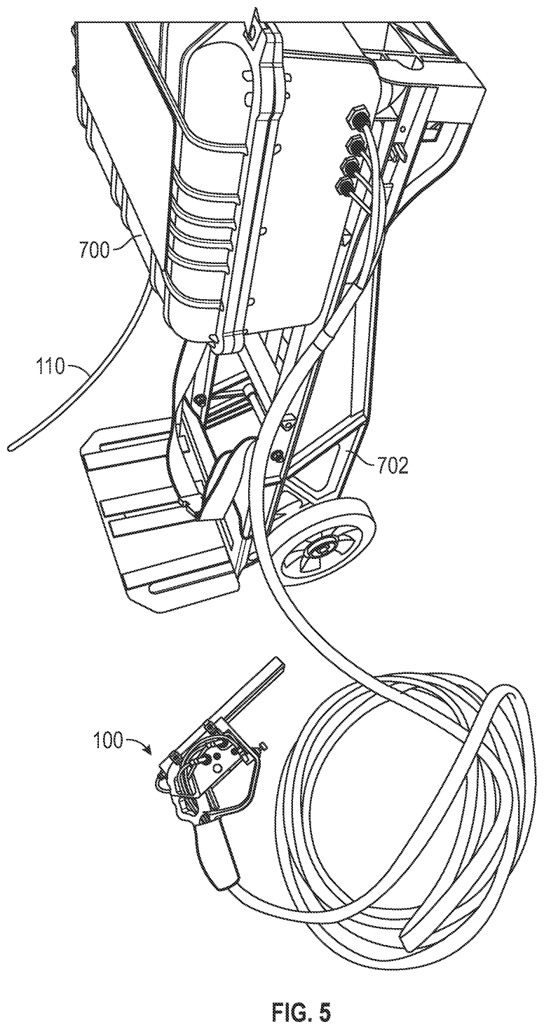

FIG. 5 is a side elevation view of the example embodiment pictured in FIG. 4, showing the handheld nozzle attached to the control panel by means of the fluid supply line, airflow supply line, airstream supply line, and control signal line.

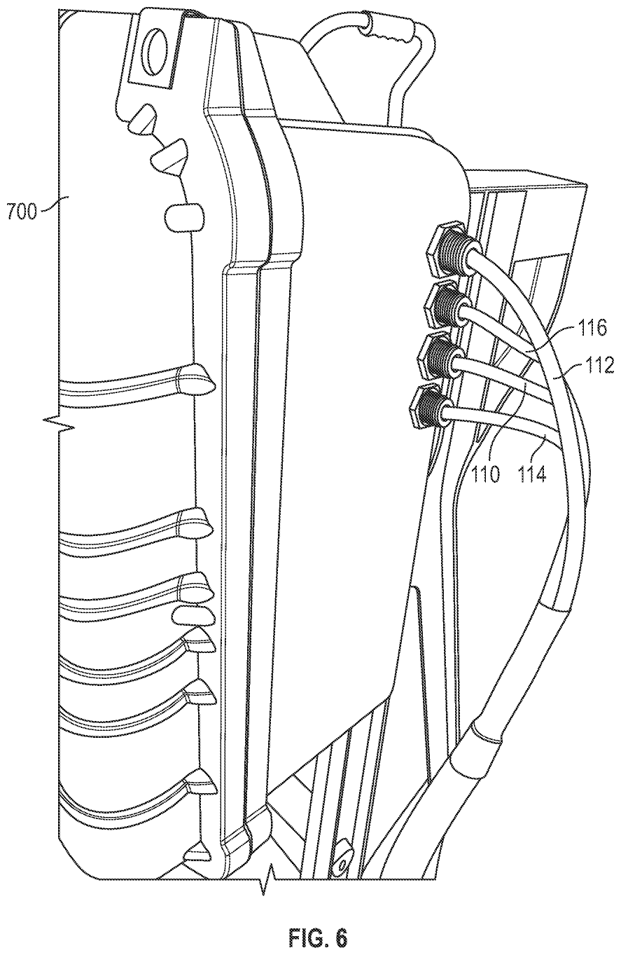

FIG. 6 is a detail view of the example embodiment pictured in FIG. 5, showing a close up view of fluid supply line, airflow supply line, airstream supply line, and control signal line.

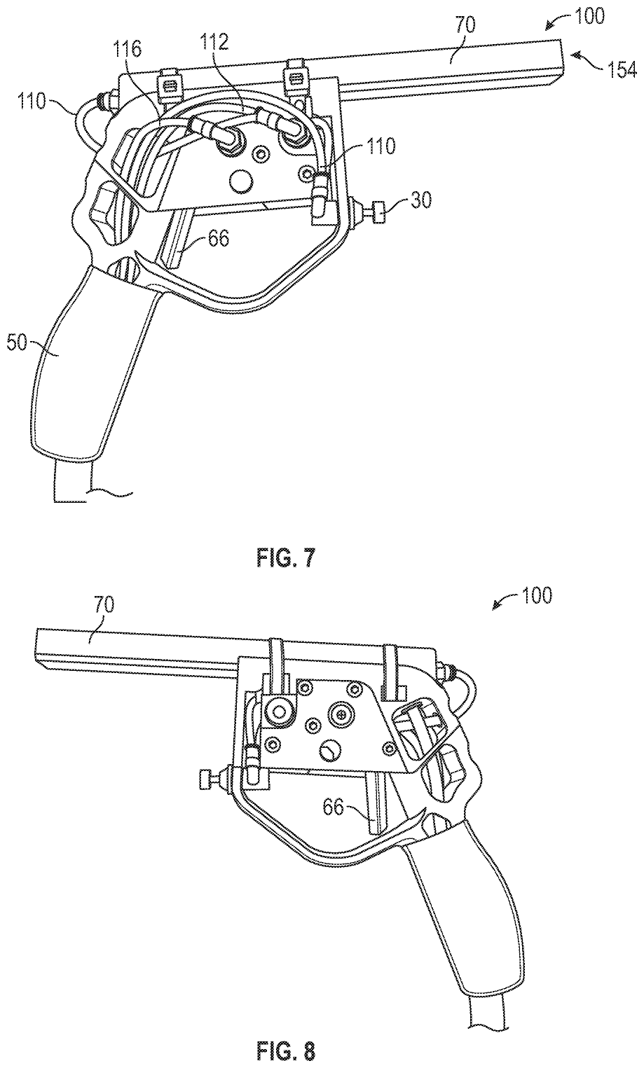

FIG. 7 is a side elevation view of the example embodiment of the handheld nozzle illustrated in FIG. 4.

FIG. 8 is a side elevation view of the other side of the example embodiment of the handheld nozzle illustrated in FIG. 7.

### DETAILED DESCRIPTION OF THE DRAWINGS

Discussing now the accompanying figures illustrating example embodiments of the instant airstream propelled spray atomizer apparatus and method of atomizing a fluid by codirectional airstream propulsion. FIG. 1 illustrates a side elevation view of a handheld nozzle 100 with central section 60 cut away to reveal interior components and connections. The handheld nozzle 100 includes a handle member 50, a central section 60, and a barrel 70. The central section 60 includes a rear side 62 and a front side 64. On the front side 64 for manual engagement by a user grasping the handle member 60 is a trigger member 66, depressible to relay an airflow and generate a control signal pressure upon a fluid drawback valve 18, to open a fluid circuit 300 to the fluid supply line 110, and simultaneously pressurize a spray air valve 26 to open the airflow circuit 200 to the airstream supply line 112. Thus, manual depression of the trigger member 66 opens the fluid circuit 300 while simultaneously instantiating the airflow circuit 200 to produce the airstream ejected from the nozzle point 150.

Release of the trigger member 66 therefore ceases airflow in the control circuit 500 and thereby simultaneously depressurizes the fluid drawback valve 18 to prevent throughflow of fluid into the fluid supply line 110 and depressurizes a spray air valve 26 to prevent airflow into the airstream supply line 112. The trigger member 66 thereby serves as a deadman control requiring active engagement for spray operations to be maintained.

As shown in FIG. 1, in cutaway section and shown fed through the handle member 50, airflow is routed to barrel 70 via airflow supply line 114 from an associated air compressor or other compressed air supply 10 which us connected in fluid communication with airflow supply line 114. Airflow into the airstream circuit 400 requires depression of trigger member 66 to route airflow into airstream supply line 112 which routes airflow into the barrel 70 for forcible direction interior to the barrel through the space surrounding interior catheter 80 (see also FIG. 2). In at least one example embodiment contemplated as part of this disclosure, pressure is further reduced by the narrowing of barrel 70 from first section 72 to second section 74, and airflow is ejected as airstream out nozzle point 150 (see for example FIG. 2).

Control signal line 116 routes a branched airflow to pressurize the fluid drawback valve 18 and actuate delivery of fluid through into fluid supply line 110. Fluid supply line routes fluid to fluid metering valve 30 for manual control, whereby the volume of fluid introduced through catheter 80 is regulable by a user, even during active spray operations. Fluid metering valve 30, disposed on the rear side of the central section, thus enables controllable introduction of fluid, from the fluid reservoir 14, into the airstream via catheter 80 (see for example FIG. 2). Mixing of the fluid into the airstream in mixing chamber 152 between terminus 82 of catheter 80 and nozzle point 150 atomizes the fluid to eject an atomized spray. See for example FIG. 2.

The atomized spray is controllable, between a minimum atomization (that is, essentially a stream of liquid fluid emitted from the nozzle when airflow is reduced to zero) and a maximum atomization (that is, generation of a mist of fine droplets in a maximized pressure differential between the fluid introduced into the airstream relative an airflow pressure interior to the barrel).

Control of the airflow may be adjustable to regulate airflow and the resulting airstream between the minimum and maximum airstreams. In some embodiments, airflow (or, in other embodiments, a first fluid flow) may be regulated by control of air pressure (or first fluid pressure), at the source itself or by action of additional metering valves (not shown). Further, in some embodiments, control of the fluid (or, as case may be, second fluid) may likewise be effectuated by control of the fluid pump 20, which is contemplated in some embodiments to be operable at a range of settings to induce a corresponding range of fluid pressures introducible into the fluid circuit 300.

FIG. 2. illustrates a longitudinal cross section of an example embodiment of the nozzle barrel 70, shown in diagrammatic form. Airflow is forced at pressure into first section 72 of barrel 70 through airstream supply line 112. Under pressure, airflow is forced through second section 74 of barrel 70, where pressure is further reduced. Airflow is directed along the barrel 70 around catheter 80, which is disposed along a central, longitudinal axis down the barrel 70 length, coaxially disposed interior to the barrel 70. Fluid is introducible into the catheter 80 through fluid supply line 110, for dispersal at terminus 82, which terminus 82 is set back a predetermined distance from barrel 70 aperture 154 at nozzle point 150. The distance between the terminus 82 and the aperture 154 represents a mixing zone 156 wherein the fluid introduced into the airstream is atomized and forcibly ejected in the airstream.

In the pressure differential extant between the airstream and fluid introduced into the mixing zone, RT instability may serve to atomize the fluid into fine droplets for conveyance as an ejected, directable mist. Control of airflow pressure interior to barrel 70 may control the atomization or aspiration of fluid ejected therefrom. Thus, a minimum pressure sustained interior to barrel 70 may result in a stream of liquid, as water from a hose, whereas a maximum pressure may eject a finely articulated spray of mist consisting of atomized water droplets of a minimized size and ejected as a cloud at force. A range of fluid applications is thereby enabled, and operable continuously during spray operations, from a directable mist or cloud to a directed jet of fluid, without a user having to cease spray operations and interchange a nozzle, element, or other structural feature of the apparatus.

FIG. 3 illustrates a diagrammatic view of an example embodiment of the method of atomizing a fluid by codirectional airstream propulsion. A compressed air supply 10 provides a pressurized airflow into airflow via compressed air regulator 12 to circuit 200 for ejection of the airstream and for instantiating a control signal for means of operating a fluid circuit 300 and airstream circuit 400. An associated fluid pump 20, disposed in operational communication with a fluid reservoir 14, pumps fluid into the fluid circuit 300 (via priming valve 16) for ejection into the airstream produced at the nozzle 100. Fluid, however, is prevented from accessing the fluid supply line 110 by action of fluid drawback valve 18, which remains closed until pressurized by means of the control signal branched into control circuit 500 from the airflow circuit 200.

Activation of the compressed air supply 10 therefore instantiates the control signal, controllable by depression of trigger member 66 to effectuate opening of trigger air valve 28. When trigger air valve 28 is opened by manual depression of the trigger member 66, the control signal pressurizes the drawback valve 18 to open throughflow of fluid pumped is by fluid pump 20 from fluid reservoir 14 to the fluid supply line 110. Air control signal also pressurizes spray air valve 26 to open airstream circuit 400 routing airflow to nozzle for ejection therefrom. Release of the trigger member 66 therefore closes air trigger valve 28, which shuts off control signal and effectuates depressurization of the spray air valve 26, to close off the airstream circuit 400 to the nozzle 100. Simultaneously, fluid drawback valve 18 is depressurized, closing off the fluid circuit 300. When depressurization of the fluid drawback valve 18 occurs, a plunger 19 reseats to seal off the fluid circuit 300 and prevent displacement of fluid remnant in the fluid supply line 110 and thereby prevent dripping from the nozzle 100.

Priming bypass valve 16 allows for priming the fluid pump 20 by bleeding air from the fluid circuit 300 between the pump 20 and the fluid circuit 300 by bypassing the fluid drawback valve 18. Thus, fluid pressure is attainable previous to spray operations when the pump 20 is primed. Once air is bled from the fluid circuit 300, the priming bypass valve 16 may be closed, the compressed air supply 10 activated, and spray operations begun. Continuous operations may be maintained even while adjusting the atomization produced at the nozzle, between the minimum atomization and the maximum atomization disclosed.

Fluid pump regulator 22 and control air regulator 24 regulate pressure within the circuits.

FIG. 4 depicts an example embodiment of a fluid supply line 110 and an airflow supply line 114 coupled to a control panel 700 that is mounted to a voluble frame member 702 (in this example embodiment, a dolly). Airflow supply line 114 is couplable to a compressor (not shown). Fluid supply line 110 is couplable to a reservoir and associated pump 20. Switch member 704 disposed upon control panel 700 housing opens a valve to is enable introduction of airflow into the airflow circuit 200. Once the airflow circuit 200 is activated, the airstream is producible when the trigger member 66 is depressed.

FIG. 5 depicts the other side of the example embodiment of apparatus shown in FIG. 4. Fluid supply line 110, airstream supply line 112, airflow supply line 114, and control signal line 116 are shown. FIG. 6 is a detail view of the embodiment shown in FIG. 5 showing the various supply lines 110, 112, 114, and 116 for routing the associated airflow circuit 200, fluid circuit 300, airstream circuit 400, and control circuit 500 by manual action effectuated at the nozzle 100.

FIGS. 7 and 8 are side elevation views of the example embodiment of the nozzle 100 shown in FIG. 5. Fluid supply line 110, airstream supply line 112, airflow supply line 114, and control signal line 116 are shown arranged upon the nozzle 100 to enable actuation of spray operations when trigger member 66 is depressed. Fluid metering valve 30 controls the volume of the second fluid introduced into the airstream to produce a spray or a mist as desired without having to change the nozzle 100. Control of the spray to mist functionality is enabled midstream. The airstream may be regulated by a valve controlling pressure of the airstream circuit (not shown) or by controlling the output pressure on the compressor (not shown).

Additional embodiments that mount the invention set forth herein to mobile, portable, or other frames and or units are contemplated as within the scope of the present disclosure.

What is claimed is:

1. An airstream propelled spray atomizer apparatus comprising:
a nozzle having an elongate barrel operatively coupled in fluid communication with a compressor, said barrel having an aperture;
a catheter disposed coaxially interior to the barrel;
a terminus disposed endwise upon the catheter;
wherein a first fluid pressurized within the compressor is selectively introducible into the barrel for ejection out of the aperture and a second fluid, disposed in fluid communication with the catheter, is selectively introducible at the terminus into the barrel whereby the second fluid is atomized by introduction into the first fluid when said first fluid is forced through the barrel.

2. The airstream propelled spray atomizer apparatus of claim 1 wherein the barrel includes a first section and a second section, said first section having an inner diameter wider than an inner diameter of the second section whereby the first fluid is accelerated by movement into the second section.

3. The airstream propelled spray atomizer apparatus of claim 2 wherein the catheter is disposed coaxially within the barrel.

4. The airstream propelled spray atomizer apparatus of claim 3 wherein the terminus is disposed in the second section of the barrel spaced back from the aperture such that the second fluid is introduced into a mixing zone interior to the barrel previous to ejection out the aperture.

5. The airstream propelled spray atomizer apparatus of claim 4 further comprising:
an airflow circuit routing the first fluid from the compressor, said airflow circuit mediated by action of a spray air valve;
a fluid circuit routing the second fluid from a reservoir connectable to the fluid circuit, said fluid circuit mediated by action of a fluid drawback valve;
a control circuit branching a control signal off of the airflow circuit when an air trigger valve is opened, said control circuit routing the control signal to pressurize the spray air valve and the fluid drawback valve;
an airstream circuit openable by action of the spray air valve, said airstream circuit in open communication with the barrel member;
a trigger member operatively communicating with the air trigger valve wherein depression of the trigger member instantiates the control signal to pressurize the fluid drawback valve and the spray air valve; and
a fluid metering valve disposed in operational communication with the fluid circuit downstream from the fluid drawback valve wherein the volume of the second fluid introduced through the catheter is regulable;
wherein depression of the trigger member initiates atomization of the second fluid into the first fluid and the fluid metering valve enables control of the volume of the second fluid atomized and whereby release of the trigger member closes the trigger valve.

6. An airstream propelled spray atomizer apparatus comprising:
a handheld nozzle having;
an elongate barrel having an aperture;
a catheter disposed interior to the barrel;
a terminus disposed endwise upon the catheter;
a handle member;
a trigger member disposed in operational communication with an air trigger valve whereby depression of the trigger member opens the air trigger valve and restoration of the trigger member closes the air trigger valve;
a fluid supply line disposed in operational communication with a fluid drawback valve and a fluid metering valve, said fluid supply line operatively couplable with a reservoir;
an airflow supply line disposed in operational communication with a spray air valve, said airflow supply line operatively couplable with a compressor;
an airstream supply line operatively coupling the barrel to the airflow supply line downstream of the spray air valve; and
a control signal line branched off of the airflow supply line to route a control signal to pressurize and open the fluid drawback valve and the spray air valve, said control signal line operationally coupled with the air trigger valve;
wherein a first fluid is forcible from the compressor as an airstream into the barrel and out the aperture and a second fluid is introducible into the airstream for atomization therein.

7. The airstream propelled spray atomizer apparatus of claim 6 further comprising a fluid metering valve disposed in communication with the fluid supply line wherein the volume of the second fluid introduced into the airstream is regulable.

8. The airstream propelled spray atomized apparatus of claim 7 wherein the catheter is disposed coaxially interior to the barrel such that the terminus is disposed interior to the second section spaced back from the aperture.

9. The airstream propelled spray atomizer apparatus of claim 8 wherein the barrel further comprises a first section and a second section, wherein the first section has an inner diameter wider than the inner diameter of the second section whereby the airstream is accelerated into the second section.

10. A method of atomizing a fluid by codirectional airstream propulsion comprising the steps of:
accelerating a first fluid along an elongate barrel towards an aperture; and
introducing a second fluid into the accelerated first fluid from a terminus coaxially disposed interior to the barrel, said terminus spaced back from the aperture to define a mixing zone;
wherein the second fluid is atomized by introduction into the first fluid for ejection from the aperture as an atomized mist.

11. The method of claim 10 wherein the amount of atomization of the second fluid is controllable by the speed the first fluid is moved through the barrel whereby the second fluid is not atomized at a minimal speed and the second fluid is maximally atomized at a maximum speed.

12. The method of 10 wherein the first fluid is accelerated down the barrel by controlled release from a compressor coupled in operative communication with the barrel.
